(19) United States
(12) Patent Application Publication
(10) Pub. No.: US 2010/0147991 A1
(43) Pub. Date: Jun. 17, 2010

(54) REEL ASSEMBLY AND METHOD OF MAKING THE SAME

(75) Inventors: Tzung-Lin Huang, Kaohsiung City (TW); Chun-Huai Huang, Kaohsiung City (TW)

Correspondence Address: CHOATE, HALL & STEWART LLP, TWO INTERNATIONAL PLACE, BOSTON, MA, 02110, US

(73) Assignee: Tzung-Lin Huang, Kaohsiung City (TW)

(21) Appl. No.: 12/463,272

(22) Filed: May 8, 2009

(30) Foreign Application Priority Data
Dec. 11, 2008 (TW) 097148196

(51) Int. Cl. B65H 75/14; B65H 75/18; B23P 11/00

(52) U.S. Cl. 242/609.1; 29/428

(57) ABSTRACT

A reel assembly includes first and second reel plates each having a central hole, a plurality of radial openings angularly spaced apart around the central hole, and a plurality of hub plate sections each extending radially into a respective opening and being bendable from a respective one of first and second reel plates to project substantially in an axial direction. The hub plate sections of the first and second reel plates form a hub body when they bend and extend between the first and second reel plates in an overlapping manner so that the hub plate sections of the first and second reel plates alternate with each other. A method of making the reel assembly is also disclosed.

### CROSS-REFERENCE TO RELATED APPLICATION

This application claims priority of Taiwanese Application No. 097148196, filed on Dec. 11, 2008, which is incorporated herein by reference.

### BACKGROUND OF THE INVENTION

1. Field of the Invention

This invention relates to a reel assembly, more particularly to a reel assembly on which there may be wound tape having a plurality of electronic components attached thereto and a method of making the same.

2. Description of the Related Art

Referring to FIG. 1, a plurality of electronic components 11 are generally disposed on a tape 12 so as to facilitate quick transfer and making of the same. The tape 12 is wound around a reel assembly (not shown) to protect the electronic components 11 and to facilitate transport of the same.

Referring to FIG. 2, a conventional reel assembly 2, as disclosed in Taiwanese Patent No. M566403, includes a hub body 21 having a clamping groove 211, and two side plates 22 connected respectively to two opposite side faces of the hub body 21. One end of the tape 12 shown in FIG. 1 is inserted into the clamping groove 211, after which the reel assembly 2 is manipulated so as to wind the tape 12 on the reel body 21 between the side plates 22. Hence, the electronic components 11 are protected within the reel assembly 2, and transport of the same is also facilitated.

Although the aforesaid reel assembly 2 can achieve its intended purpose, the reel assembly 2 has three separate components that must be assembled prior to use and that must be disassembled to facilitate storage. Further, assembly and disassembly of the reel assembly 2 consume a lot of time. Moreover, since the hub body 21 is large, a significant amount of space is used for storage.

FIG. 3 illustrates another conventional reel assembly. The conventional reel assembly of FIG. 3 can be made of paper or plastic, and includes two side plates 200 connected respectively to two opposite sides of a hub body 300. It has the same disadvantages as the conventional reel assembly 2 shown in FIG. 2.

Referring to FIGS. 4 and 5, a conventional reel assembly 3, as disclosed in U.S. Pat. No. 4,726,534, includes first and second reel plates 31, 32 that are interconnected to each other and that are identical to each other. Each of the first and second reel plates 31, 32 includes a plurality of hub plate sections 311, 321 projecting inwardly from a respective one of the first and second reel plates 31, 32, and a base wall 33, 33′ connected to the hub plate sections 311, 321 and generally parallel to the respective one of the first and second reel plates 31, 32. The base wall 33, 33′ is provided with six spaced-apart engaging ears 34, and six through holes 331 for extension of the respective engaging ears 34 of the base wall 33, 33′ of a corresponding first or second reel plate 31, 32 so that the engaging ears 34 of the base wall 33, 33′ of the first and second reel plates 31, 32 can be inter-engaged, thereby interconnecting the first and second reel plates 31, 32. The hub plate sections 311, 321 of the first and second reel plates 31, 32 form a hub body 35 of the reel assembly 3 after the interconnection.

Although the reel assembly 3 includes only two components, the interlocking structures of the components are complicated, so that the manufacturing processes of the reel assembly 3, such as forming and molding, are difficult. This results in high manufacturing cost of the reel assembly 3. Further, the reel assembly 3 occupies a substantial storage space, regardless of whether it is in an assembled or a disassembled state.

### SUMMARY OF THE INVENTION

Therefore, an object of the present invention is to provide a reel assembly that has a low manufacturing cost and a method of making the same.

According to one aspect of this invention, a reel assembly comprises first and second reel plates each having a central hole, and a plurality of angularly spaced-apart hub plate sections extending substantially axially from a respective one of the first and second reel plates around the central hole. The hub plate sections of the first and second reel plates form a hub body when they extend between the first and second reel plates in an overlapping manner so that the hub plate sections of the first and second reel plates alternate with each other.

According to another aspect of this invention, a reel assembly comprises first and second reel plates each having a central hole, a plurality of radial openings angularly spaced apart around the central hole, and a plurality of hub plate sections each extending radially into a respective opening and being bendable from a respective one of first and second reel plates to project substantially in an axial direction. The hub plate sections of the first and second reel plates form a hub body when they bend and extend between the first and second reel plates in an overlapping manner so that the hub plate sections of the first and second reel plates alternate with each other.

According to still another aspect of this invention, a method of making a reel assembly comprises the steps of: preparing first and second reel plates; providing first and second central holes respectively in the first and second reel plates; slitting each of the first and second reel plates so that the first reel plate has a plurality of angularly spaced-apart radially extending first hub plate sections surrounding the first central hole and the second reel plate has a plurality of angularly spaced-apart radially extending second hub plate sections surrounding the second central hole; bending substantially axially each of the first and second hub plate sections so that the first reel plate is formed with a plurality of angularly spaced-apart radial first openings and the second reel plate is formed with a plurality of angularly spaced-apart radial second openings; placing the first and second hub plate sections between the first and second reel plates in an overlapping manner so that the first and second hub plate sections alternate with each other to form a hub body; and connecting the first hub plate sections to the second reel plate and connecting the second hub plate sections to the first reel plate.

### BRIEF DESCRIPTION OF THE DRAWINGS

Other features and advantages of the present invention will become apparent in the following detailed description of the preferred embodiments of the invention, with reference to the accompanying drawings, in which:

FIG. 1 is a perspective view of a tape loaded with a plurality of electronic components;

FIG. 2 is an exploded perspective view of a conventional reel assembly disclosed in Taiwanese Patent No. M566403;

FIG. 3 is a partly exploded perspective view of another conventional reel assembly;

FIG. 4 is a schematic side view of a conventional reel assembly disclosed in U.S. Pat. No. 4,726,534;

FIG. 5 is a schematic top view of the conventional reel assembly of FIG. 4;

FIG. 6 is a perspective view of an embodiment of a first reel plate of a reel assembly;

FIG. 7 is a perspective view of an embodiment of a second reel plate of the reel assembly;

FIG. 8 is a schematic side view of an embodiment of the first and second reel plates in an assembled state;

FIG. 9 is a perspective view of an embodiment of the first and second plates in an assembled state;

FIG. 10 is a perspective view of an embodiment in a state of use;

FIG. 11 is a flow chart, illustrating an embodiment of the steps involved in making the reel assembly;

FIG. 12 is a perspective view of the first and second reel plates prepared in an embodiment of a first step of making the reel assembly;

FIG. 13 is a view similar to FIG. 12, but illustrating the first and second reel plates respectively provided with a central hole and a plurality of radially extending hub plate sections;

FIG. 14 is a bottom view, illustrating the hub plate sections of the first and second reel plates in a state bent in an axial direction;

FIG. 15 is a view similar to FIG. 14, but illustrating distal ends of the hub plate sections of the first and second reel plates in a bent state;

FIG. 16 is a perspective view of another embodiment of a first reel plate of a reel assembly;

FIG. 17 is a perspective view of another embodiment of the reel assembly in an assembled state;

FIG. 18 is a perspective view of another embodiment of a first reel plate of a reel assembly; and

FIG. 19 is a perspective view of another embodiment of the reel assembly in an assembled state.

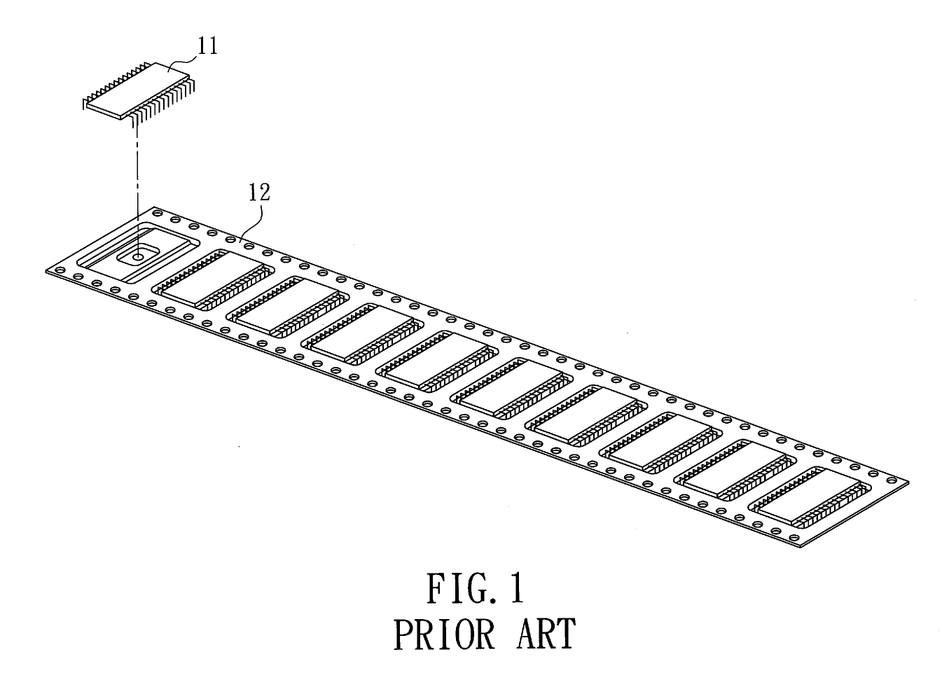

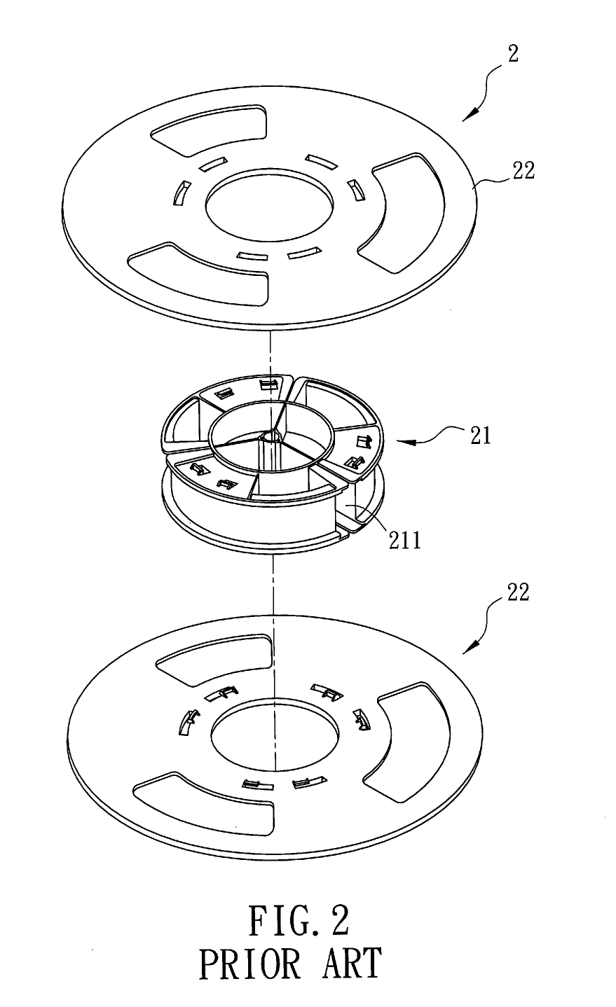

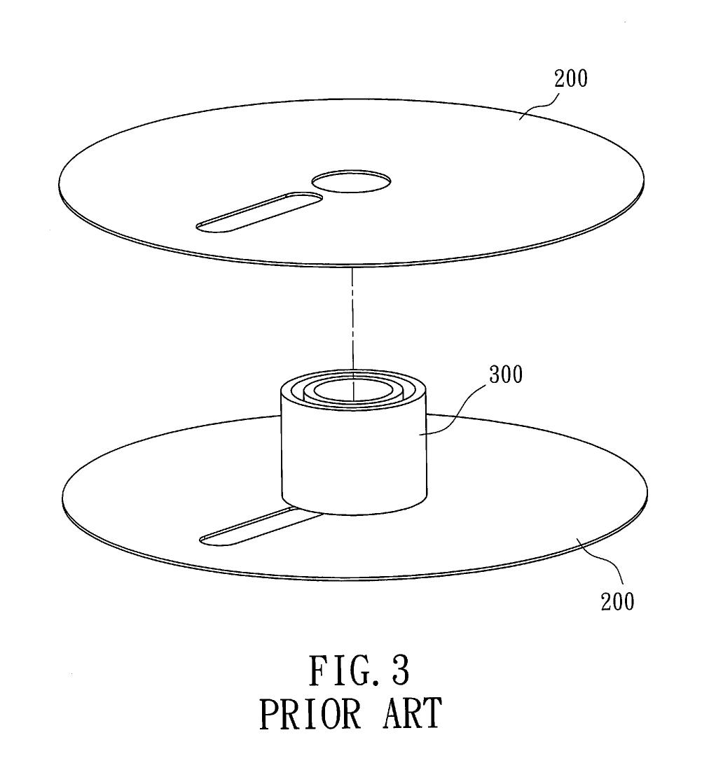

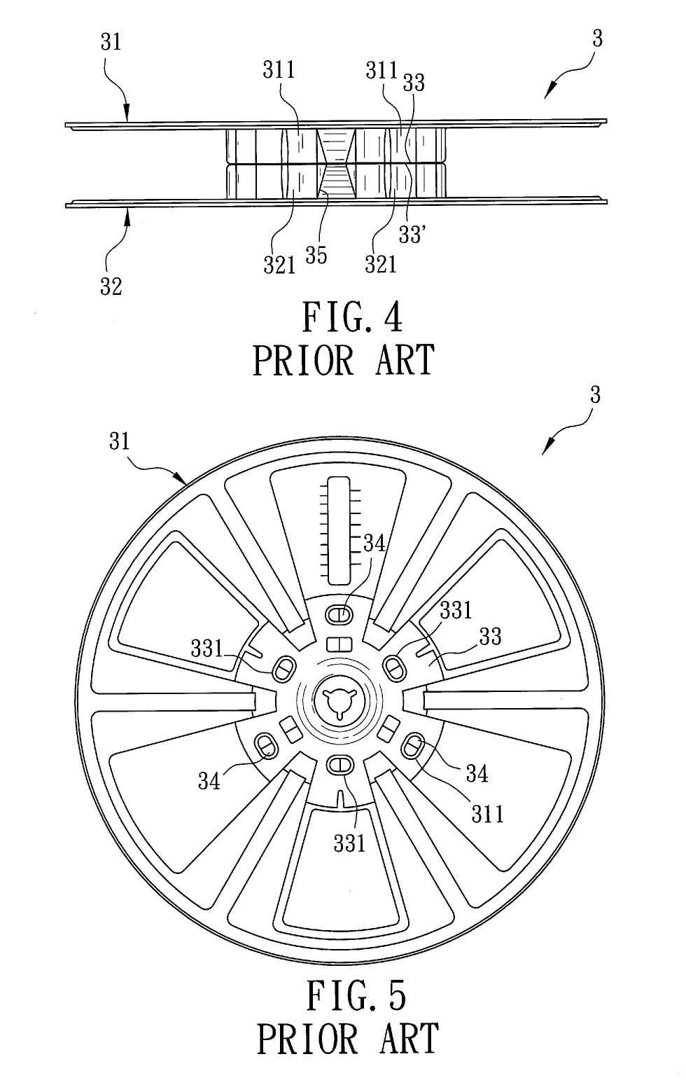

### DETAILED DESCRIPTION

Before the present invention is described in greater detail, it should be noted that the same reference numerals have been used to denote like elements throughout the specification.

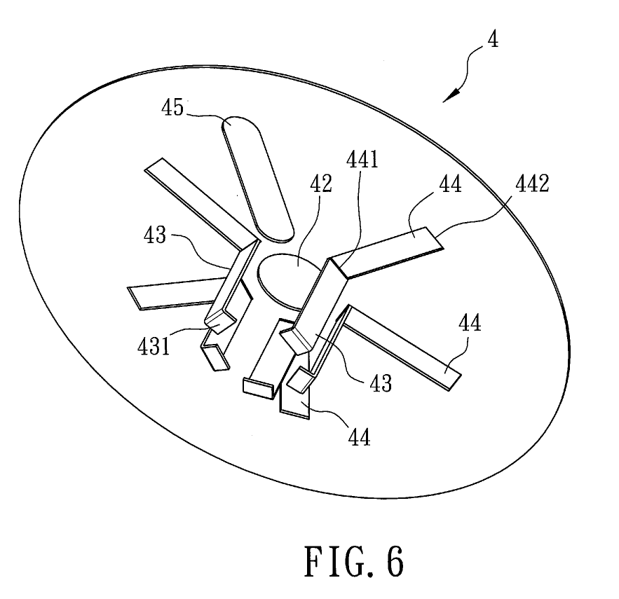

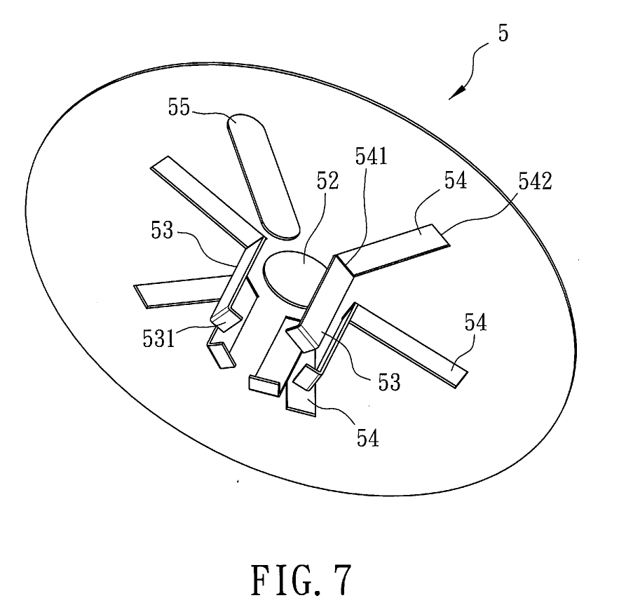

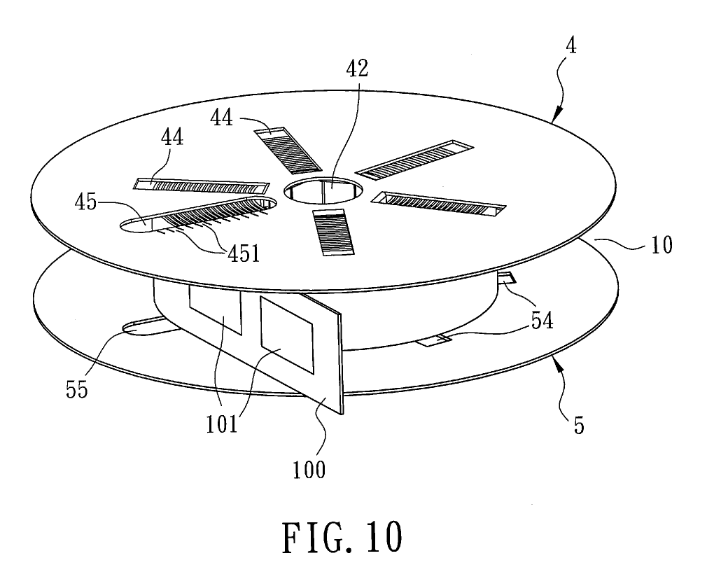

Referring to FIGS. 6 and 7, a reel assembly is adapted to wind a reel tape 100 (see FIG. 10) that is loaded with a plurality of electronic components 101 (see FIG. 10), and is shown to comprise first and second reel plates 4, 5.

The first reel plate 4 has a first central hole 42, a plurality of radial first openings 44 angularly spaced apart around the first central hole 42, a plurality of first hub plate sections 43 each extending radially into one of the first openings 44 and being bendable from the first reel plate 4 to project substantially in an axial direction, and a first view hole 45 disposed between two adjacent ones of the first openings 44. Each first opening 44 has an inner end 441 proximate to the first central hole 42, and an outer end 442 distal from the first central hole 42. Each first hub plate section 43 projects substantially axially from the inner end 441 of a respective first opening 44, and has a bent distal end 431.

The second reel plate 5 has a second central hole 52, a plurality of radial second openings 54 angularly spaced apart around the second central hole 52, and an outer end 542 distal from the second central hole 52, a plurality of second hub plate sections 53 each extending radially into one of the second openings 54 and being bendable from the second reel plate 5 to project substantially in an axial direction, and a second view hole 55 disposed between two adjacent ones of the second openings 54. Each second opening 54 has an inner end 541 proximate to the second central hole 52, and an outer end 542 distal from the second central hole 52. Each second hub plate section 53 projects substantially axially from the inner end 541 of a respective second opening 54, and has a bent distal end 531.

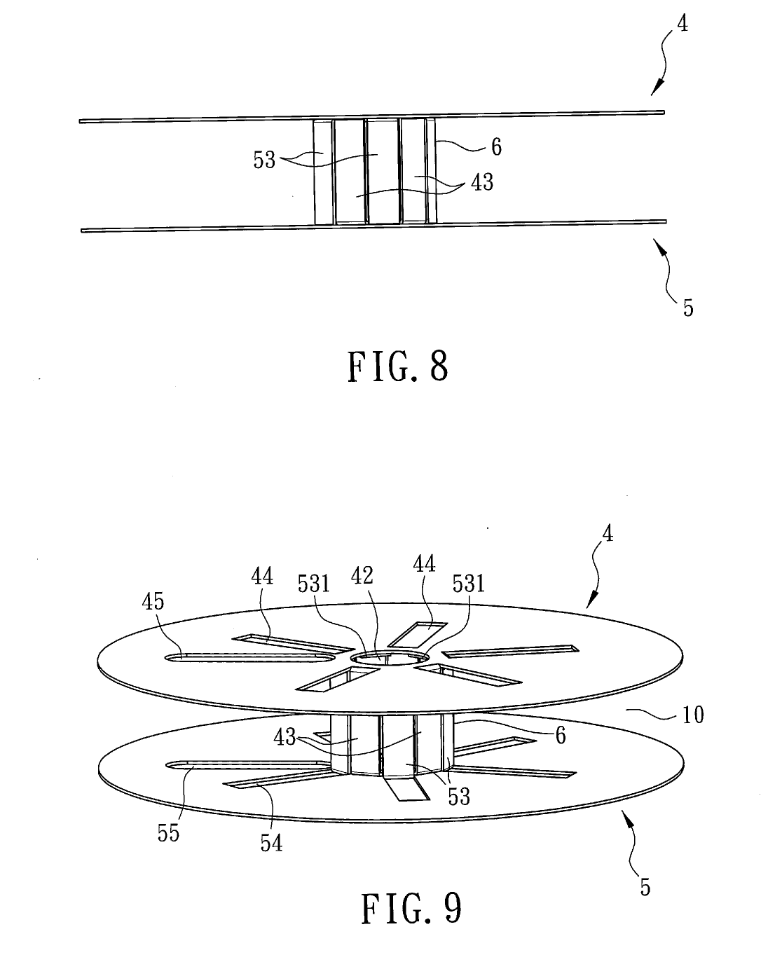

Referring to FIGS. 8 and 9, in combination with FIG. 10, the first and second hub plate sections 43, 53 form a hub body 6 for winding the reel tape 100 when the first and second hub plate sections 43, 53 bend and extend between the first and second reel plates 4, 5 in an overlapping manner so that the first and second hub plate sections 43, 53 alternate with each other. The bent distal ends 431 of the first hub plate sections 43 are glued to the second reel plate 5, while the bent distal ends 531 of the second hub plate sections 53 are glued to the first reel plate 4. The first and second reel plates 4, 5 and the hub body 6 cooperatively define a receiving space 10 for receiving the reel tape 100. The first and second view holes 45, 55 are aligned to each other after assembly of the first and second reel plates 4, 5 to permit viewing of the amount of the reel tape 100 in the receiving space 10. Two opposite sides of each of the first and second view holes 45, 55 may also be provided with graduation marks 451 so that the amount of the reel tape 100 in the receiving space 10 may be more accurately determined. The first and second view holes 45, 55 may also be used as a basis for alignment during assembly of the first and second reel plates 4, 5, so that when the first and second view holes 45, 55 are aligned, the first and second hub plate sections 43, 53 can be smoothly overlapped in an alternating manner between the first and second reel plates 4, 5 to form the hub body 6. In an alternative embodiment, the first and second view holes 45, 55 may be dispensed with, in which case, the amount of the reel tape 100 in the receiving space 10 may be directly viewed through the radial first and second openings 44, 54. Hence, in the absence of the first and second view holes 45, 55, each of the first and second reel plates 4, 5 may be provided with more hub plate sections 43, 53, so that the alternately arranged first and second hub plate sections 43, 53 can form a substantially continuous circular hub body 6.

It should be noted that the first and second reel plates 4, 5 are substantially mirror images of each other, and the first and second reel plates 4, 5 are made of hard cardboard in order to minimize the material costs. However, they may be made of plastic materials, if necessary.

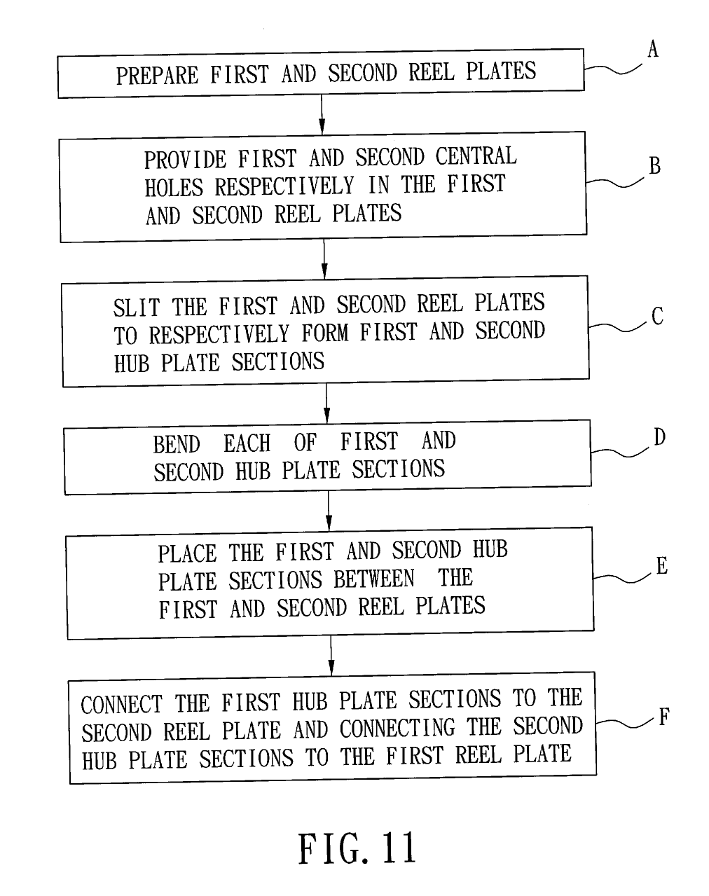

Referring to FIG. 11, a method of making the reel assembly includes steps (A) to (F).

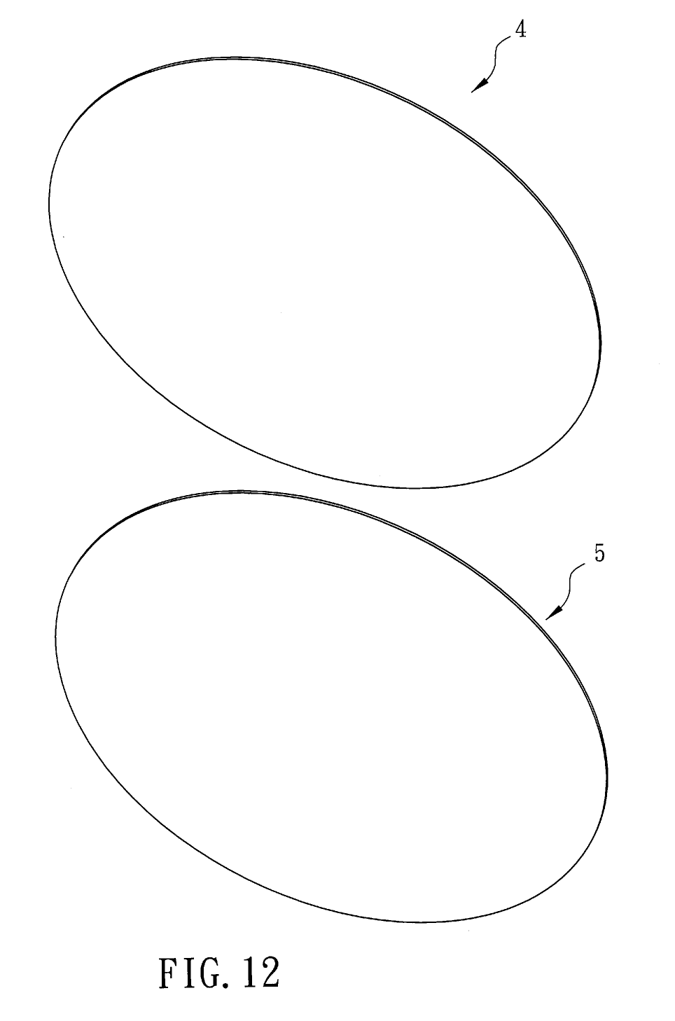

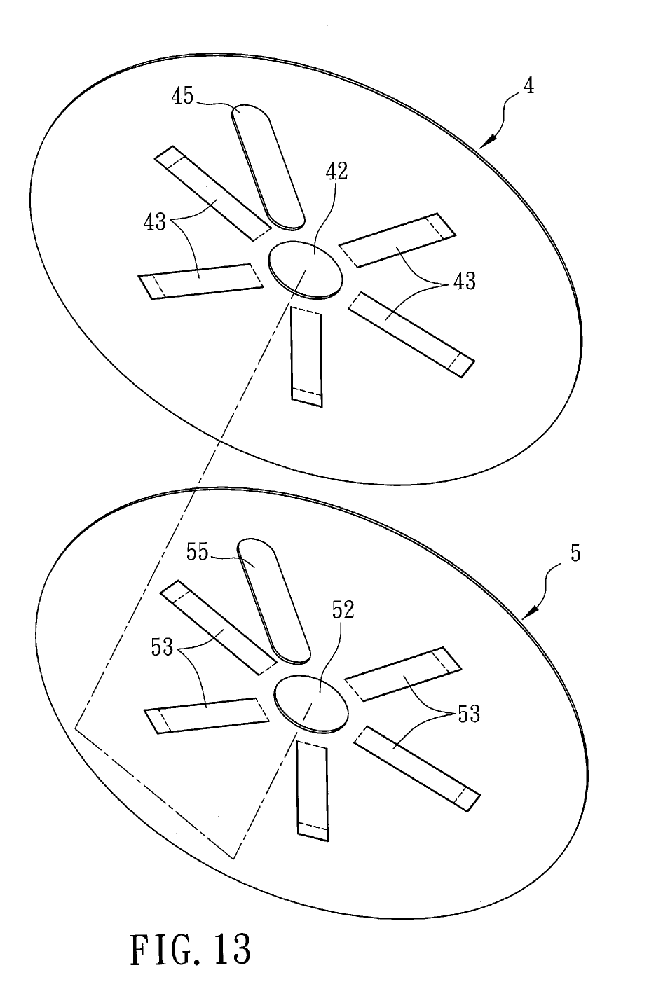

In step (A), referring to FIG. 12, first and second reel plates 4, 5 made of hard cardboard are prepared. In step (B), referring to FIG. 13, the first reel plate 4 is formed with a first central hole 42 and a first view hole 45, and the second reel plate 5 is formed with a second central hole 52 and a second view hole 55.

In step (C), referring again to FIG. 13, each of the first and second reel plates 4, 5 is slitted, so that the first reel plate 4 has a plurality of angularly spaced-apart radially extending first hub plate sections 43 surrounding the first central hole 42, and the second reel plate 5 has a plurality of angularly spaced-apart radially extending second hub plate sections 53 surrounding the second central hole 52. Further, in this step, a plurality of fold lines (shown in phantom lines) are printed on the first and second reel plates 4, 5 and on the first and second hub plate sections 43, 53 to facilitate the succeeding bending steps. The first view hole 45 is formed between two adjacent ones of the first hub plate sections 43, while the second view hole 55 is formed between two adjacent ones of the second hub plate sections 53.

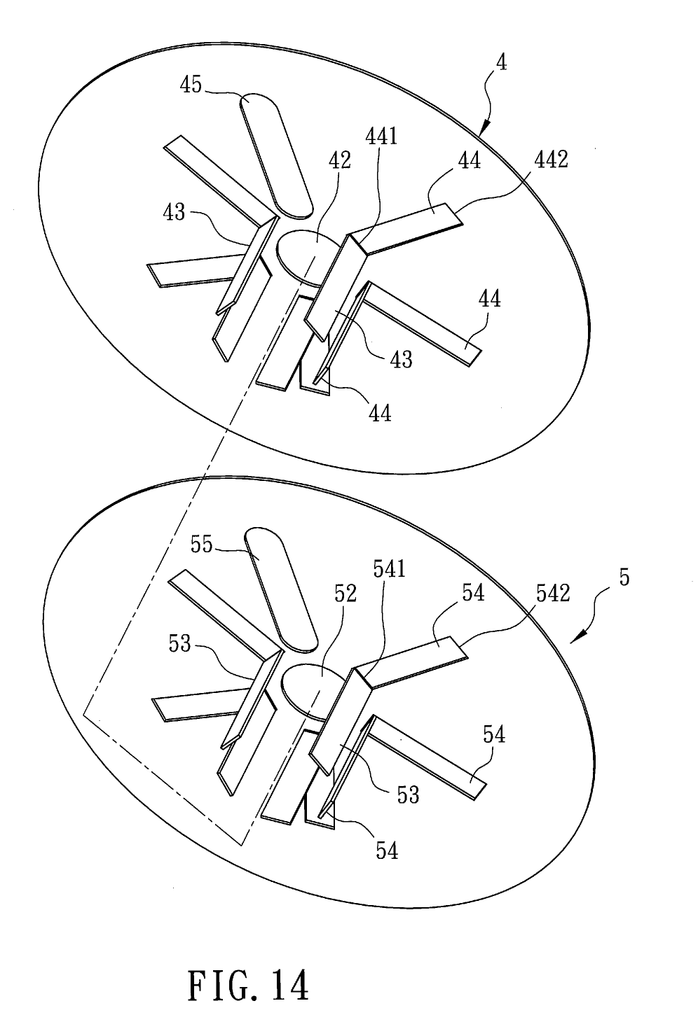

In step (D), referring to FIG. 14, each of the first and second hub plate sections 43, 53 is bent along the fold lines that are printed on the first and second reel plates 4, 5 until the first hub plate sections 43 extend substantially axially from the first reel plate 4 and the second hub plate sections 53 extend substantially axially from the second reel plate 5. At this time, a plurality of angularly spaced-apart radial first openings 44 are formed in the first reel plate 4, and a plurality of angularly spaced-apart radial second openings 54 are formed in the second reel plate 5. Each first opening 44 has an inner end 441 proximate to the first central hole 42, and an outer end 442 distal from the first central hole 42. Each second opening 54 has an inner end 541 proximate to the second central hole 52, and an outer end 542 distal from the second central hole 52. Hence, the fold lines on the first and second reel plates 4, 5 come to be printed on the inner ends 441, 541 of the first and second openings 44, 54. Also, as a result of such bending, the first and second hub plate sections 43, 53 extend substantially axially from the inner ends 441, 541 of the respective first and second openings 44, 54.

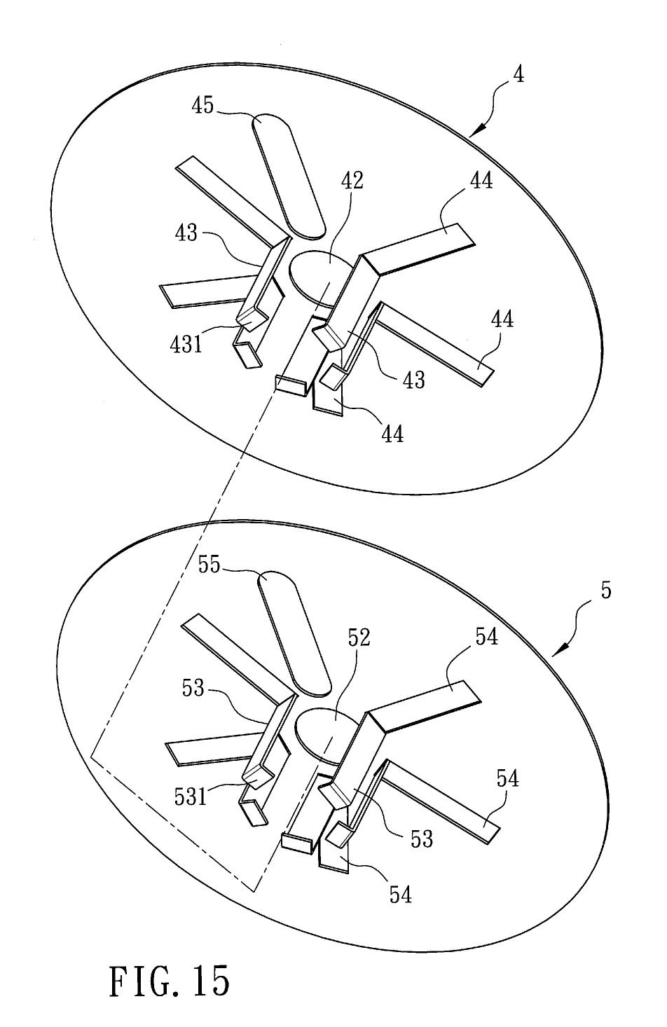

After the first and second hub plate sections 43, 53 are bent, distal ends 431 of the first hub plate sections 43 and distal ends 531 of the second hub plate sections 53 are bent inwardly along the fold lines that are printed on the respective first and second hub plate sections 43, 53, as best shown in FIG. 15.

In step (E), referring back to FIGS. 8 and 9, the first and second hub plate sections 43, 53 are placed between the first and second reel plates 4, 5 in an overlapping manner so that the first and second hub plate sections 43, 53 alternate with each other to form the hub body 6. The first and second reel plates 4, 5 and the hub body 6 cooperatively define the receiving space 10 for receiving the reel tape 100 (see FIG. 10).

In step (F), the distal ends 431 of the first hub plate sections 43 are connected to the second reel plate 5 (not visible in FIG. 9), and the distal ends 531 of the second hub plate sections 53 are connected to the first reel plate 4 (see FIG. 9). In this embodiment, the connecting of the distal ends 431 to the second reel plate 5 and the connecting of the distal ends 531 to the first reel plate 4 are carried out by gluing. In an alternative embodiment, the connecting of the distal ends 431 to the second reel plate 5 and the connecting of the distal ends 531 to the first reel plate 4 may be carried out by other means, such as by the use of a stapler, bending engagement, etc.

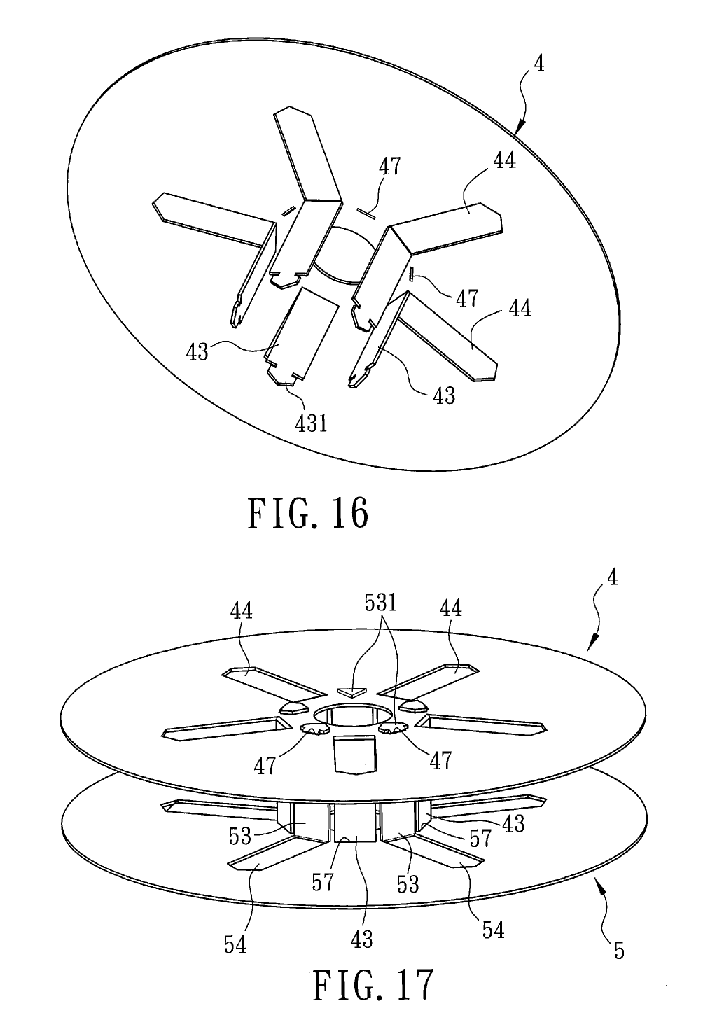

Referring to FIGS. 16 and 17, another embodiment of the reel assembly according is shown to be similar to the embodiments of FIGS. 6 and 7. However, in this embodiment, the first reel plate 4 further has a plurality of angularly spaced-apart first engaging holes 47 each formed between two adjacent ones of the first openings 44, and the second reel plate 5 further has a plurality of angularly spaced-apart second engaging holes 57 each formed between two adjacent ones of the second openings 54. The distal end 431 of each first hub plate section 43 extends through a respective second engaging hole 57, and bends thereafter to form a hook that is hooked to the second reel plate 5 (not visible in FIG. 17). The distal end 531 of each second hub plate section 53 extends through a respective first engaging hole 47, and bends thereafter to form a hook that is hooked to the first reel plate 4. Through such connections, use of a fixing means, such as a stapler, adhesive, etc., is dispensed herewith.

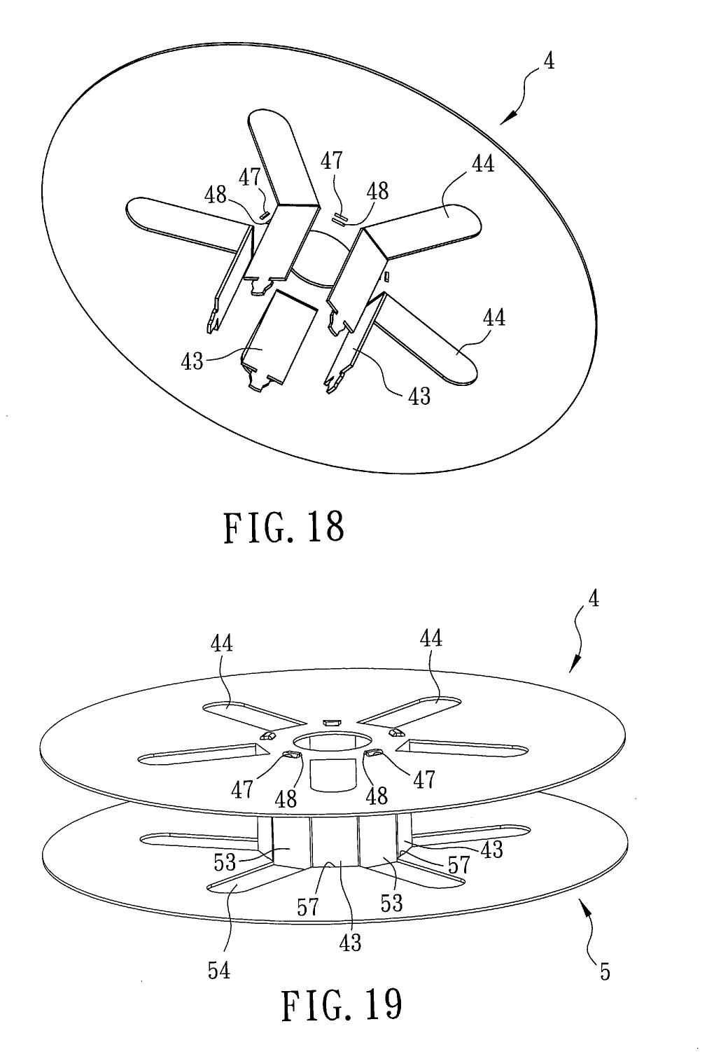

Referring to FIGS. 18 and 19, another embodiment of the reel assembly is shown to be similar to the embodiment of FIGS. 16 and 17. However, in this embodiment, the first reel plate 4 further has a plurality of angularly spaced-apart third engaging holes 48 which are proximate to the first engaging holes 47, respectively, and the second reel plate 5 further has a plurality of angularly spaced-apart fourth engaging holes (not visible) which are proximate to the second engaging holes 57, respectively. The distal end 431 of each first hub plate section 43 extends through a respective second engaging hole 57, bends thereafter to form a hook, and then extends into and engages one of the fourth engaging holes. The distal end 531 of each second hub plate section 53 extends through a respective first engaging hole 47, bends thereafter to form a hook, and then extends into and engages one of the third engaging holes 48. In this embodiment, the fixing connection of the first and second reel plates 4, 5 is enhanced and more stable.

It should be noted that since the first and second reel plates 4, 5 are substantially mirror images of each other, only the structure of the first reel plate 4 is detailed in the second and third embodiments. Further, the reel assembly in each of the second and third embodiments is not provided with a view hole. The amount of the reel tape in the reel assembly can be directly viewed through the first and second openings 44, 54.

The advantages of the reel assembly of the present invention and the method of making the same can be summarized as follows:

1. The first and second reel plates 4, 5 can be stored in a semi-finished state, i.e., after performing steps (B) and (C), as shown in FIG. 13. Since each of the first and second reel plates 4, 5 is formed as a single thin plate body, the reel plates 4, 5 can be stacked one over the other uniformly without occupying a substantial space. When the reel assembly is required, steps (D) to (F) are performed to interconnect the first and second reel plates 4, 5.

2. The first and second reel plates 4, 5 are made of hard cardboard, and undergo steps (B) and (C) to form the first and second central holes 42, 52 and the first and second hub plate sections 43, 53. The first and second hub plates sections 43, 53 are bent, then extend between the first and second reel plates 4, 5 in an overlapping manner so as to alternate with each other, after which the distal ends 431 of the first hub plate sections 43 are connected to the second reel plate 5, and the distal ends 531 of the second hub plate sections 53 are connected to the first reel plate 4, thereby forming the reel assembly of the present invention. Hence, making of the reel assembly of the present invention is relatively simple. Further, since the material of the reel assembly of the present invention is hard cardboard instead of plastic, which is customarily used in the making of the conventional reel assemblies, not only can the material cost be minimized, the complicated steps involved in using the plastic materials, such as forming, molding, etc., may also be dispensed herewith, so that the manufacturing costs of the present invention can be effectively minimized.

While the present invention has been described in connection with what are considered the most practical and preferred embodiments, it is understood that this invention is not limited to the disclosed embodiments but is intended to cover various arrangements included within the spirit and scope of the broadest interpretations and equivalent arrangements.

1. A reel assembly comprising:
a first reel plate having a first central hole, a plurality of angularly spaced-apart first hub plate sections extending substantially axially from said first reel plate around said first central hole, and a plurality of radial first openings angularly spaced apart around said first central hole, each of said first openings having an inner end proximate to said first central hole, and an outer end distal from said first central hole, each of said first hub plate sections being connected to and bent from said inner end of one of said radial first openings to project substantially axially from said inner end of a respective said radial first opening; and
a second reel plate having a second central hole, and a plurality of angularly spaced-apart second hub plate sections extending substantially axially from said second reel plate around said second central hole, and a plurality of radial second openings angularly spaced apart around said second central hole, each of said second openings having an inner end proximate to said second central hole, and an outer end distal from said second central hole, each of said second hub plate sections being connected to and bent from said inner end of one of said radial second openings to project substantially axially from said inner end of a respective said radial second opening;
wherein said first and second hub plate sections form a hub body when said first and second hub plate sections are disposed axially between said first and second reel plates in an alternating manner.

2. (canceled)

3. (canceled)

4. The reel assembly of claim 1, wherein each of said first hub plate sections has a bent distal end glued to said second reel plates, and each of said second hub plate sections has a bent distal end glued to said first reel plate.

5. The reel assembly of claim 1, wherein said first reel plate further has a plurality of angularly spaced-apart first engaging holes each formed between two adjacent ones of said first openings, each of said second hub plate sections having a distal end extending through a respective one of said first engaging holes and bending thereafter to form a first hook, said second reel plate further having a plurality of angularly spaced-apart second engaging holes each formed between two adjacent ones of said second openings, each of said first hub plate sections having a distal end extending through a respective one of said second engaging holes and bending thereafter to form a second hook.

6. The reel assembly of claim 5, wherein said first reel plate further has a plurality of third engaging holes which are proximate to said first engaging holes, respectively, said distal end of each of said second hub plate sections extending into one of said third engaging holes after forming said first hook, said second reel plate further having a plurality of fourth engaging holes which are proximate to said second engaging holes, respectively, said distal end of each of said first hub plate sections extending into one of said fourth engaging holes after forming said second hook.

7. A method of making a reel assembly, comprising:
(A) preparing first and second reel plates;
(B) providing first and second central holes respectively in said first and second reel plates;
(C) slitting each of said first and second reel plates so that said first reel plate has a plurality of angularly spaced-apart radially extending first hub plate sections surrounding said first central hole, and so that said second reel plate has a plurality of angularly spaced-apart radially extending second hub plate sections surrounding said second central hole;
(D) bending substantially axially each of said first and second hub plate sections so that said first reel plate is formed with a plurality of angularly spaced-apart radial first openings and said second reel plate is formed with a plurality of angularly spaced-apart radial second openings;
(E) bending a distal end of each of said first and second hub plate sections;
(F) placing said first and second hub plate sections between said first and second reel plates in an alternating manner; and
(G) connecting said bent distal ends of said first hub plate sections to said second reel plate and connecting said bent distal ends of said second hub plate sections to said first reel plate.

8. The method of claim 7, wherein the connecting of said first hub plate sections to said second reel plate and the connecting of said second hub plate sections to said first reel plate are carried out by gluing.

9. The method of claim 7, wherein the connecting of said first hub plate sections to said second reel plate and the connecting of said second hub plate sections to said first reel plate are carried out in an interlocking manner.
